(19) United States
(12) Patent Application Publication
(10) Pub. No.: US 2020/0072974 A1
(43) Pub. Date: Mar. 5, 2020

(54) DISTANCE MEASURING APPARATUS, DISTANCE MEASURING METHOD, AND PROGRAM

(71) Applicant: SONY SEMICONDUCTOR SOLUTIONS CORPORATION, KANAGAWA (JP)

(72) Inventors: TAKAHIRO OKADA, SAITAMA (JP); TAKAHIRO MIYAZAKI, KANAGAWA (JP); TAKASHI HAGIWARA, KANAGAWA (JP)

(21) Appl. No.: 16/489,948

(22) PCT Filed: Mar. 22, 2018
(86) PCT No.: PCT/JP2018/011249

§ 371 Date: Aug. 29, 2019

(30) Foreign Application Priority Data
Apr. 4, 2017 (JP) 2017-074396

(51) Int. Cl. G01S 15/32; H04B 11/00

(52) U.S. Cl. CPC G01S 15/32; H04B 11/00

(57) ABSTRACT

The present technology relates to a distance measuring apparatus, a distance measuring method, and a program that enable accurate measurement of the distance to a target. A distance measuring apparatus according to one aspect of the present technology includes: an OFDM modulation unit configured to generate an OFDM signal by performing OFDM modulation on a transmission signal; an output unit configured to output the OFDM signal by using an ultrasonic wave as a carrier wave; a collecting unit configured to collect, as a reception signal, an ultrasonic wave as a reflected wave from a target of the ultrasonic wave output from the output unit; a demodulation unit configured to generate a demodulated signal by demodulating the reception signal; a calculation unit configured to calculate a delay profile on the basis of an own signal obtained in the process of generating the OFDM signal and the demodulated signal; and an arithmetic operation unit configured to determine delay time of the ultrasonic wave from the delay profile and to arithmetically operate the distance to the target on the basis of the delay time. The present technology can be applied to, for example, an automobile.

### TECHNICAL FIELD

The present technology relates to a distance measuring apparatus, a distance measuring method, and a program, and in particular, to a distance measuring apparatus, a distance measuring method, and a program for irradiating a target with an ultrasonic wave and measuring the distance to the target on the basis of the reflected wave of the ultrasonic wave.

### BACKGROUND ART

Conventionally, as a distance measuring apparatus for performing distance measurement using an ultrasonic wave, there is an apparatus using a pulse echo system (see, for example, Patent Document 1).

Here, an ultrasonic wave indicates a sound wave (elastic wave) whose frequency (number of vibrations) is so high that a person with normal hearing does not have a sense of hearing.

FIG. 1 is a block diagram illustrating an example of a conventional configuration of a distance measuring apparatus adopting a pulse echo system.

The distance measuring apparatus includes a transmission unit 1, a reception unit 2, a timer 11, an interface unit 9, and a control unit 10.

The transmission unit 1 has an oscillation unit 3, a drive unit 4, and an ultrasonic speaker 5 (hereinafter referred to as a speaker 5). The reception unit 2 has an ultrasonic microphone 6 (hereinafter referred to as a microphone 6), an amplifying and detecting unit 7, and a Schmitt trigger unit 8.

In the distance measuring apparatus, an ultrasonic wave is output from the speaker 5 of the transmission unit 1 toward a target the distance to which is desired to be measured, and the reflected wave of the ultrasonic wave is collected by the microphone 6 of the reception unit 2.

The electric signal corresponding to the reflected wave collected by the microphone 6 is amplified and detected by the amplifying and detecting unit, and the amplitude thereof is compared with a predetermined threshold by the Schmitt trigger unit 8, and the Schmitt trigger which is the comparison result is supplied to the timer 11.

The timer 11 counts the timing at which the ultrasonic wave is transmitted and the timing at which the reflection is collected, and outputs the timings to the control unit 10 via the interface unit 9. The control unit 10 calculates a time difference td between the both timings and applies the time difference td to the following equation (1) to calculate the distance L to the target. Here, v is the speed of the ultrasonic wave.

L=v×td/2 (1)

FIG. 2 illustrates timings of output and collection of ultrasonic waves and the like in the distance measuring apparatus of FIG. 1.

For example, if a measurement request pulse of a rectangular wave illustrated in A of FIG. 2 is supplied from the control unit 10 to the oscillation unit 3 via the interface unit 9, the oscillation unit 3 outputs an ultrasonic wave signal corresponding to the measurement request signal to the drive unit 4 as illustrated in B of FIG. 2. The drive unit 4 causes the speaker 5 to vibrate correspondingly to this ultrasonic wave signal to cause the speaker 5 to output an ultrasonic wave. However, as illustrated in C of FIG. 2, the waveform of the ultrasonic wave output from the speaker 5 is distorted due to the characteristics thereof, environmental sound, or the like, and the waveform of the reflected wave from the target is further distorted as illustrated in D of FIG. 2.

The Schmitt trigger unit 8 compares the amplitude of the reflected wave illustrated in D of FIG. 2 with a predetermined detection threshold as illustrated in E of FIG. 2, and supplies Schmitt trigger output as illustrated in F of FIG. 2 illustrating the comparison result to the timer 11. The timer 11 notifies the control unit 10 of the timing at which the ultrasonic wave is transmitted, and detects rising timing of the Schmitt trigger output illustrated in F of FIG. 2 as the timing at which the ultrasonic wave is collected and notifies the control unit 10 of the rising timing. The control unit 10 calculates the difference between the both timings as the time difference td and uses the time difference td to calculate the distance L to the target.

### CITATION LIST

### Patent Document Patent Document 1: Domestic re-publication of PCT international application No. 2005-106530

### SUMMARY OF THE INVENTION

### Problems to be Solved by the Invention

As described above, since the Schmitt trigger output depends on the detection threshold in a Schmitt trigger circuit 8, in a case where the amplitude of the collected reflected wave is attenuated or the detection threshold is not properly set, it is not possible to correctly detect the rising timing of the trigger output, in other words, the timing at which the ultrasonic wave is collected. Therefore, in this case, since an error occurs in the time difference td, the accuracy of the distance L calculated on the basis of the time difference td also decreases.

The present technology has been proposed in view of such a situation, and enables accurate measurement of the distance to a target by detecting td, which is the time difference between transmission and reception timings of an ultrasonic wave, with high accuracy.

### Solutions to Problems

A distance measuring apparatus according to one aspect of the present technology includes: an OFDM modulation unit configured to generate an OFDM signal by performing OFDM modulation on a transmission signal; an output unit configured to output the OFDM signal by using an ultrasonic wave as a carrier wave; a collecting unit configured to collect, as a reception signal, an ultrasonic wave as a reflected wave from a target of the ultrasonic wave output; a demodulation unit configured to generate a demodulated signal by demodulating the reception signal; a calculation unit configured to calculate a delay profile on the basis of an own signal obtained in the process of generating the OFDM signal and the demodulated signal; and an arithmetic operation unit configured to determine delay time of the ultrasonic wave from the delay profile and to arithmetically operate the distance to the target on the basis of the delay time.

The distance measuring apparatus according to one aspect of the present technology may further include a division unit configured to generate a transfer function by dividing the demodulated signal by the OFDM signal, in which the calculation unit may calculate the delay profile by performing an inverse Fourier transform on the transfer function.

The distance measuring apparatus according to one aspect of the present technology may further include an orthogonal modulation unit configured to perform orthogonal modulation of the OFDM signal before being carried by the ultrasonic wave, in which the demodulation unit can generate the demodulated signal by performing orthogonal demodulation corresponding to the orthogonal modulation on the reception signal and performing Fourier transform.

The OFDM modulation unit may provide a guard interval to the OFDM signal.

The OFDM modulation unit may provide the guard interval having a same length as OFDM effective symbol length.

The OFDM modulation unit may set an FFT size to a power of 2, the FFT size being a parameter in the OFDM modulation unit, and may set the number of carrier waves to ½ of the FFT size.

The distance measuring apparatus according to one aspect of the present technology may further include: a replica signal generation unit configured to generate a replica signal corresponding to a crosstalk component; and a subtraction unit configured to subtract the replica signal from the reception signal.

The distance measuring apparatus according to one aspect of the present technology may further include a crosstalk measurement unit configured to measure crosstalk information, in which the replica signal generation unit may generate the replica signal on the basis of the crosstalk information.

The crosstalk measurement unit may measure, as the crosstalk information, at least one of delay time, attenuation of the amplitude of the OFDM signal, or rotation of a phase corresponding to crosstalk.

The crosstalk measurement unit may periodically update the crosstalk information.

The crosstalk measurement unit may update the crosstalk information in a case where a peak corresponding to crosstalk appears in the delay profile.

The distance measuring apparatus according to one aspect of the present technology may further include: a cancel unit configured to correct distortion of the reception signal caused by a frequency characteristic of an ultrasonic speaker as the output unit and an ultrasonic microphone as the collecting unit.

The cancel unit may be included in the OFDM modulation unit.

The cancel unit may multiply an inverse characteristic of the frequency characteristic of the ultrasonic speaker and the ultrasonic microphone, in the process of generating the OFDM signal.

A distance measuring method according to one aspect of the present technology, the measuring method performed by a distance measuring apparatus, the method, by the distance measuring apparatus, including: an OFDM modulation step of generating an OFDM signal by performing OFDM modulation on a transmission signal; an output step of outputting the OFDM signal by using an ultrasonic wave as a carrier wave; a collecting step of collecting, as a reception signal, an ultrasonic wave as a reflected wave from a target of the ultrasonic wave output; a demodulation step of demodulating a demodulated signal by demodulating the reception signal; a calculation step of calculating a delay profile on the basis of an own signal obtained in a process of generating the OFDM signal and the demodulated signal; and an arithmetic operation step of determining delay time of the ultrasonic wave from the delay profile and arithmetically operating the distance to the target on the basis of the delay time.

A program according to one aspect of the present technology causing a computer to function as: an OFDM modulation unit configured to generate an OFDM signal by performing OFDM modulation on a transmission signal; an output unit configured to output the OFDM signal by using an ultrasonic wave as a carrier wave; a collecting unit configured to collect, as a reception signal, an ultrasonic wave as a reflected wave from a target of the ultrasonic wave output; a demodulation unit configured to generate a demodulated signal by demodulating the reception signal; a calculation unit configured to calculate a delay profile on the basis of an own signal obtained in the process of generating the OFDM signal and the demodulated signal; and an arithmetic operation unit configured to determine delay time of the ultrasonic wave from the delay profile and to arithmetically operate the distance to the target on the basis of the delay time.

According to one aspect of the present technology, an OFDM signal is generated by performing OFDM modulation on a transmission signal, the OFDM signal is output by using an ultrasonic wave as a carrier wave, an ultrasonic wave as a reflected wave from a target of the ultrasonic wave output is collected as a reception signal, a demodulated signal is generated by demodulating the reception signal, a delay profile is calculated on the basis of an own signal obtained in the process of generating the OFDM signal and the demodulated signal, delay time of the ultrasonic wave is determined from the delay profile, and the distance to the target is arithmetically operated on the basis of the delay time.

### EFFECTS OF THE INVENTION

According to one aspect of the present technology, it is possible to accurately measure the distance to a target.

### BRIEF DESCRIPTION OF DRAWINGS

FIG. 1 is a block diagram illustrating an example of a conventional configuration of a distance measuring apparatus adopting a pulse echo system.

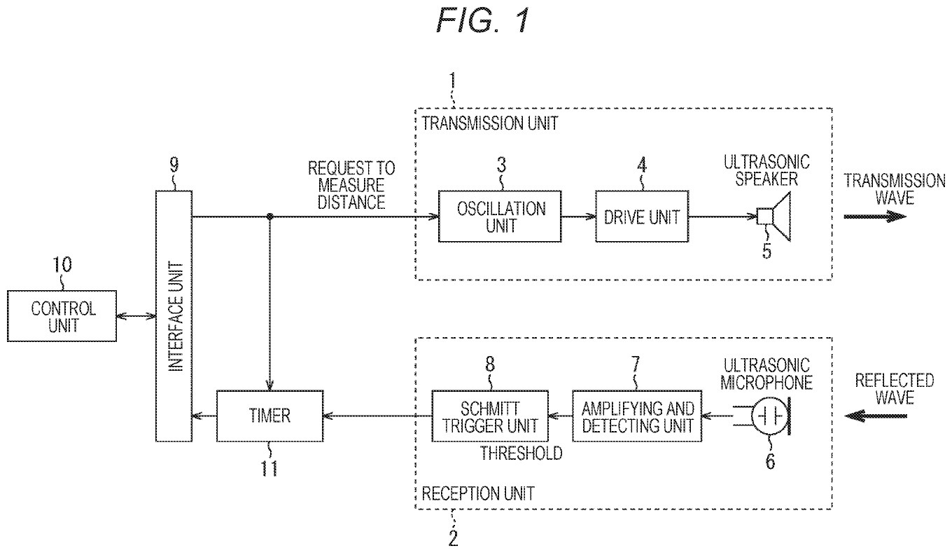

FIG. 2 is a diagram for explaining the problem of the pulse echo system.

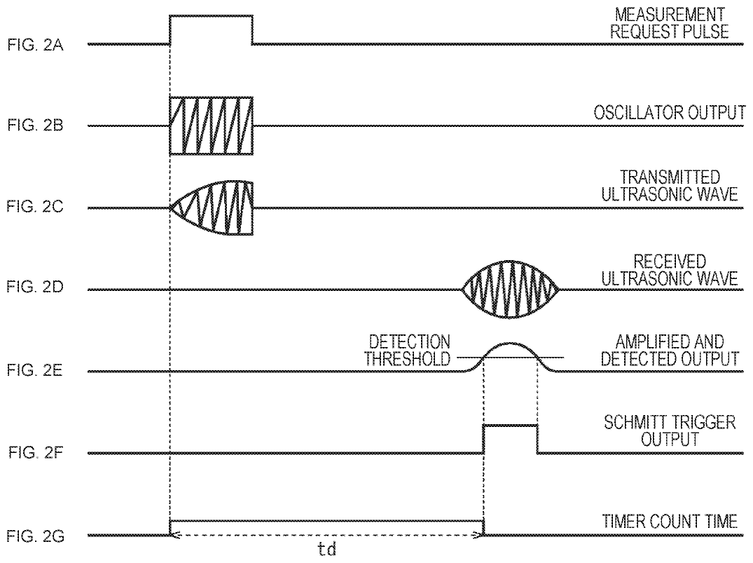

FIG. 3 is a block diagram illustrating a configuration example of a distance measuring apparatus according to a first embodiment of the present technology.

FIG. 4 is a diagram illustrating an OFDM signal to which a guard interval is added.

FIG. 5 is a diagram illustrating examples of parameters related to OFDM modulation.

FIG. 6 is a diagram illustrating an example of a delay profile.

FIG. 7 is a flowchart explaining operation of the distance measuring apparatus according to the first embodiment of the present technology.

FIG. 8 is a diagram illustrating paths of ultrasonic waves in a case where multipath occurs.

FIG. 9 is a diagram illustrating timings of output, collection of ultrasonic waves, and the like in a case where multipath occurs.

FIG. 10 is a diagram illustrating a delay profile corresponding to a case where multipath occurs.

FIG. 11 is a diagram illustrating delay profiles corresponding to the case where multipath occurs.

FIG. 12 is a diagram illustrating timings of output and collection of ultrasonic waves and the like in a case where crosstalk occurs.

FIG. 13 is a diagram illustrating a delay profile corresponding to a case where crosstalk occurs.

FIG. 14 is a block diagram illustrating a configuration example of a distance measuring apparatus according to a second embodiment of the present technology.

FIG. 15 is a diagram illustrating a delay profile corresponding to a case where a replica signal corresponding to a crosstalk component is subtracted.

FIG. 16 is a diagram illustrating an ideal frequency characteristic of a speaker and a microphone.

FIG. 17 is a diagram illustrating an example of an actual frequency characteristic of the speaker and the microphone.

FIG. 18 is a diagram for explaining a problem that occurs in the delay profile due to the frequency characteristic of the speaker and the microphone.

FIG. 19 is a block diagram illustrating a configuration example of a distance measuring apparatus according to a third embodiment of the present technology.

FIG. 20 is a diagram illustrating an inverse characteristic of the frequency characteristic of the speaker and the microphone illustrated in FIG. 17.

FIG. 21 is a block diagram illustrating a configuration example of a general-purpose computer.

FIG. 22 is a block diagram illustrating an example of a schematic configuration of a vehicle control system.

FIG. 23 is an explanatory diagram an example of installation locations of an outside-vehicle information detection unit and imaging units.

### MODE FOR CARRYING OUT THE INVENTION

Hereinafter, the best mode for carrying out the present technology (hereinafter, referred to as an embodiment) will be described in detail with reference to the drawings.

Hereinafter, although the best mode for carrying out the present disclosure (hereinafter, referred to as an embodiment) will be described with reference to the drawings, before that, an outline of the present technology will be described.

<Overview of Distance Measuring Apparatus according to Present Technology>

A distance measuring apparatus to which the present technology is applied is same as that of a conventional pulse echo system in that the distance measuring apparatus outputs an ultrasonic wave upon measurement of the distance to a target, collects the reflected wave thereof, and determines the time required for transmission and reception of the ultrasonic wave. However, the point of difference is that the distance measuring apparatus transmits and receives an ultrasonic wave as a carrier wave of an orthogonal frequency division multiplexing (OFDM) modulated signal (hereinafter referred to as an OFDM signal), and determines the time taken to transmit and receive the ultrasonic wave by arithmetic operation. With this arrangement, compared to a case where Schmitt trigger output is determined as in a conventional case, the time required for transmission and reception of an ultrasonic wave can be accurately determined, and the distance to a target can be arithmetically operated with high accuracy.

<Regarding Configuration of Distance Measuring Apparatus according to First Embodiment of Present Technology>

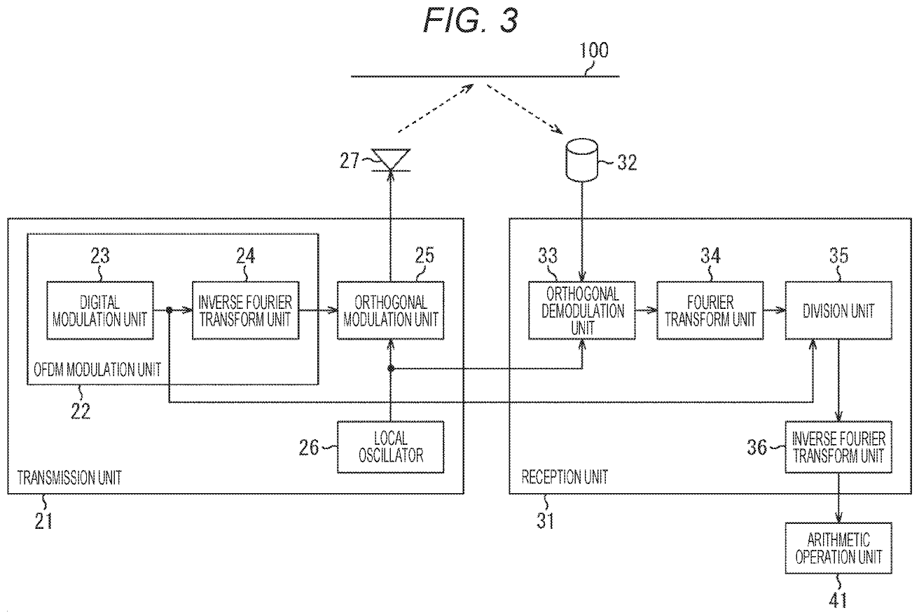

FIG. 3 is a block diagram illustrating a configuration example of a distance measuring apparatus according to a first embodiment of the present technology.

The first embodiment includes: a transmission unit 21 that outputs an ultrasonic wave to a target 100; a reception unit 31 that collects the reflected wave (reception signal) thereof and determines a time difference between transmission and reception timings; and an arithmetic operation unit 41 that arithmetically operates the distance to the target 100 on the basis of the time difference between the transmission and reception timings. Note that it is assumed that the transmission unit 21 and the reception unit 31 are disposed adjacent to each other.

The transmission unit 21 includes an OFDM modulation unit 22, an orthogonal modulation unit 25, a local oscillator 26, and an ultrasonic speaker 27 (hereinafter referred to as a speaker 27).

The OFDM modulation unit 22 has a digital modulation unit 23 and an inverse Fourier transform unit 24. For example, the digital modulation unit 23 performs predetermined digital modulation on a transmission signal such as a rectangular wave, and outputs the phase and the amplitude obtained as a result to the inverse Fourier transform unit 24. Note that the phase and the amplitude obtained as a result of the predetermined digital modulation are also notified to a division unit 35 of the reception unit 31 as an own signal. The inverse Fourier transform unit 24 performs inverse Fourier transform on the output of the digital modulation unit 23 to generate an OFDM signal corresponding to the transmission signal, moreover, adds a guard interval, and outputs the obtained signal to the orthogonal modulation unit 25.

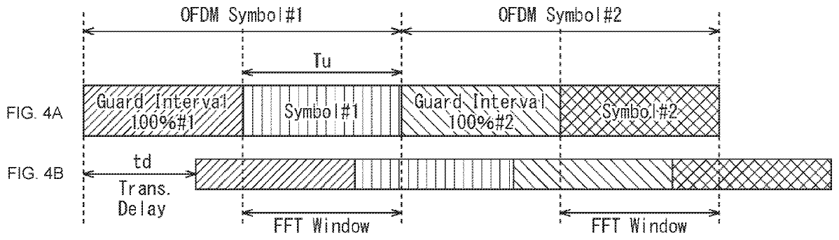

FIG. 4 illustrates a timing chart in a case where a guard interval is added to an OFDM signal and the OFDM signal is transmitted and received. Note that A of FIG. 4 illustrates a transmission timing, and B of FIG. 4 illustrates a reception timing. As illustrated, by adding a guard interval between symbols of the OFDM signal, although the transmitted and received signals become redundant, it is possible to suppress the influence of multipath as described later.

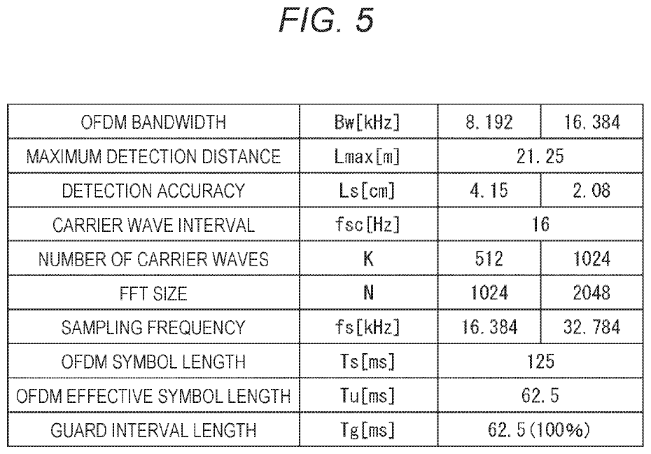

FIG. 5 illustrates examples of parameters regarding OFDM modulation in the OFDM modulation unit 22.

Specifically, an OFDM bandwidth, maximum detection distance, detection accuracy, carrier wave interval, number of carrier waves, FFT size, sampling frequency, OFDM symbol length, OFDM effective symbol length, and guard interval length are illustrated.

Note that although FIG. 5 illustrates a case where the OFDM bandwidth is set to 8.192 kHz or 16.384 kHz, the OFDM bandwidth is not limited to these two types.

Among the listed parameters, the maximum detection distance, the carrier wave interval, the OFDM symbol length, and the OFDM effective symbol length are common regardless of the OFDM bandwidth, and the others are changed according to the OFDM bandwidth.

The FFT (Fourier Transform) size being set to a power of 2 and the number of carrier waves being set to ½ thereof can be mentioned as characteristics of the parameters in the OFDM modulation unit 22. For example, the FFT size is 1024 (=2¹⁰ in a case where the OFDM bandwidth is 8.192 kHz and the number of carrier waves at that time is 512, and the FFT size is 20484 (=2¹¹) in a case where the OFDM bandwidth is 16.384 kHz and the number of carrier waves at that time is 1024. As described above, by setting the FFT size to the power of 2 and the number of carrier waves to ½ thereof, it is possible to reduce the arithmetic operation load upon OFDM modulation and OFDM demodulation. In particular, it is possible to reduce the arithmetic operation amount of Fourier transform and inverse Fourier transform.

Moreover, the guard interval length being set to the same as the OFDM effective symbol length can be mentioned. With this arrangement, interference between symbols can be prevented more effectively, and the delay time that can be acquired from the delay profile can be extended to the longest, and the maximum detection distance representing the distance to the measurable target 100 can be extended to the longest.

Returning to FIG. 3. The orthogonal modulation unit 25 provides an OFDM signal which is supplied from the inverse Fourier transform unit 24 and to which a guard interval is added, performs orthogonal modulation, and causes the speaker 27 to output an ultrasonic wave centered on the carrier wave frequency f0. The local oscillator 26 supplies a clock signal of the carrier wave frequency f0 to the orthogonal modulation unit 25. Note that it is assumed that the local oscillator 26 notifies in advance the orthogonal demodulation unit 33 of the reception unit 31 of the carrier wave frequency f0.

The reception unit 31 includes an ultrasonic microphone 32 (hereinafter referred to as a microphone 32), an orthogonal demodulation unit 33, a Fourier transform unit 34, the division unit 35, and an inverse Fourier transform unit 36.

The microphone 32 collects an ultrasonic wave output from the speaker 27 and reflected by the target 100, and outputs a reception signal corresponding to the ultrasonic wave to the orthogonal demodulation unit 33.

The orthogonal demodulation unit 33 performs, on the reception signal input from the microphone 32, orthogonal demodulation corresponding to orthogonal modulation by the orthogonal modulation unit 25 of the transmission unit 21, and outputs an orthogonal demodulated signal obtained as a result to the Fourier transform unit 34. Note that since the orthogonal demodulation unit 33 holds information associated with the carrier wave frequency f0 in advance, it is possible to omit a process such as carrier wave reproduction.

The Fourier transform unit 34 performs Fourier transform on the orthogonal demodulated signal, and outputs the result to the division unit 35.

The division unit 35 arithmetically operates the transfer function of the reflected wave by dividing the result of the Fourier transform by the Fourier transform unit 34 by the own signal supplied from the OFDM modulation unit 22 of the transmission unit 21 and outputs the transfer function to the inverse Fourier transform unit 36. The inverse Fourier transform unit 36 performs inverse Fourier transform on the transfer function, and outputs a delay profile obtained as a result, enabling acquisition of the time required for transmission and reception time of the OFDM signal to the arithmetic operation unit 41.

Note that the principle of determining the delay profile from the transfer function of the reflected wave is disclosed in, for example, “Introduction to Digital Signal Processing”, Kenichi Kido, Maruzen Co., Ltd. as an established existing technology.

The arithmetic operation unit 41 determines the time difference td from the delay profile and applies the time difference td to the equation (1) to arithmetically operate the distance to the target 100.

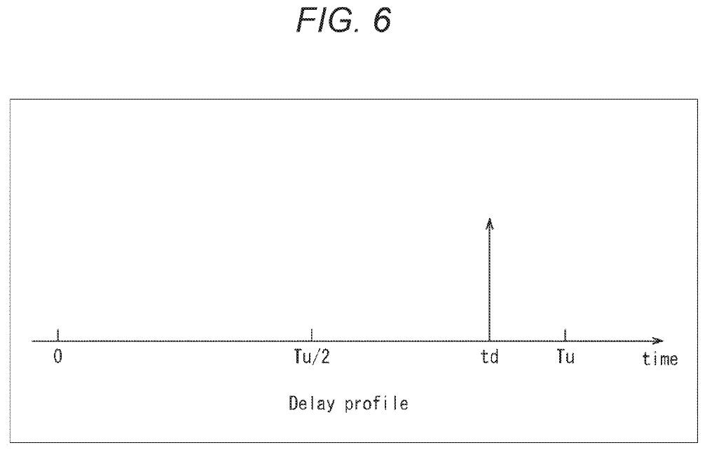

FIG. 6 illustrates an example of a delay profile obtained by performing inverse Fourier transform on the transfer function.

As illustrated in the FIG. 6, in the delay profile, the greatest peak appears in the time taken for transmission and reception time of the OFDM signal. Therefore, the arithmetic operation unit 41 can determine the time required for the transmission and reception time of the OFDM signal by detecting the peak in the delay profile.

<Regarding Operation of Distance Measuring Apparatus according to First Embodiment of Present Technology>

Next, the operation of the distance measuring apparatus according to the first embodiment of the present technology will be described.

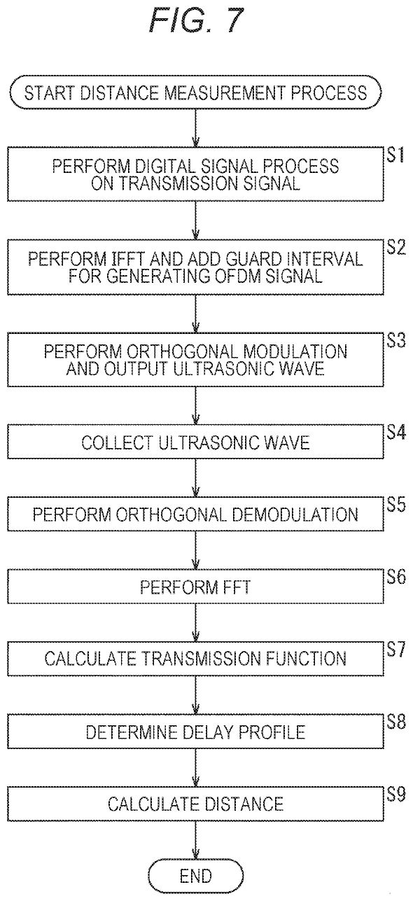

FIG. 7 is a flowchart illustrating transmission processes performed by the transmission unit 21.

Upon measurement of the distance to the target 100, in step S1, in the transmission unit 21, the digital modulation unit 23 of the OFDM modulation unit 22 performs predetermined digital modulation on the transmission signal such as a rectangular wave, and outputs the phase and amplitude obtained as a result to the inverse Fourier transform unit 24. In step S2, the inverse Fourier transform unit 24 performs inverse Fourier transform on the output of the digital modulation unit 23 to generate an OFDM signal corresponding to the transmission signal, and further adds a guard interval to the OFDM signal and outputs the obtained OFDM signal to the orthogonal modulation unit 25.

In step S3, the orthogonal modulation unit 25 performs orthogonal modulation on the OFDM signal provided with the guard interval and supplied from the inverse Fourier transform unit 24, and outputs the obtained OFDM signal from the speaker 27 as an ultrasonic wave centered on the carrier wave frequency f0. The ultrasonic wave is reflected by the target 100.

In step S4, the reception unit 31 collects the reflected wave of the ultrasonic wave reflected by the target 100, and outputs a reception signal corresponding to the reflected wave to the orthogonal demodulation unit 33.

In step S5, orthogonal demodulation corresponding to orthogonal modulation by the orthogonal modulation unit 25 of the transmission unit 21 is performed on the reception signal input from the microphone 32 and an orthogonal demodulated signal obtained as a result is output to the Fourier transform unit 34. In step S6, the Fourier transform unit 34 performs Fourier transform on the orthogonal demodulated signal, and outputs the result to the division unit 35.

In step S7, the division unit 35 arithmetically operates the transfer function of the reflected wave by dividing the result of the Fourier transform by the Fourier transform unit 34 by own signal information supplied from the OFDM modulation unit 22 of the transmission unit 21 and outputs the transfer function to the inverse Fourier transform unit 36.

In step S8, the inverse Fourier transform unit 36 performs inverse Fourier transform on the transfer function input from the division unit 35, and outputs the delay profile obtained as a result to the arithmetic operation unit 41.

In step S9, the arithmetic operation unit 41 detects the time difference td from the delay profile, applies the time difference td to the equation (1), and calculates the distance to the target 100.

The above is explanation of the operation of the distance measuring apparatus according to the first embodiment of the present technology. As described above, in the distance measuring apparatus according to the first embodiment of the present technology, the transfer function is determined by arithmetic operation, the delay profile is determined from the transfer function, and the time difference td is detected, without using Schmitt trigger output as in the pulse echo system. Therefore, the time difference td can be determined more accurately than in the pulse echo system, and the distance to the target 100 can be measured with high accuracy. Furthermore, since the guard interval of the OFDM signal is provided, the influence of multipath can be reduced.

Here, a delay profile in a case where multipath occurs will be described.

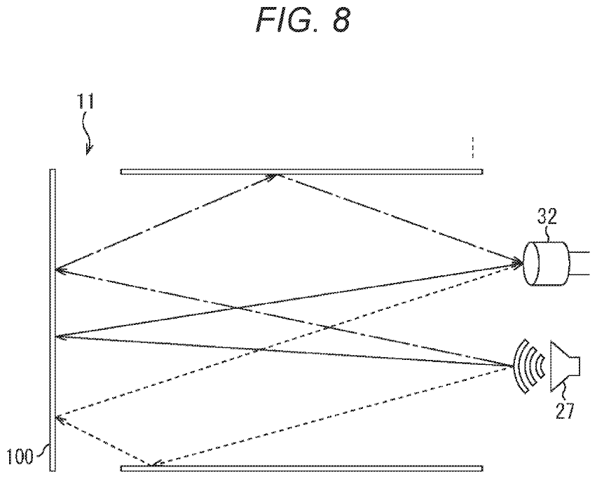

FIG. 8 illustrates a case where multipath occurs in ultrasonic waves output from the distance measuring apparatus according to the first embodiment of the present technology. In other words, as a path of ultrasonic waves output from the speaker 27, it is desirable that the ultrasonic wave directly reaches the target 100 from the speaker 27 and a reflected wave thereof is directly collected by the microphone 32 as on a path illustrated by solid lines. However, depending on the situation, as in a path indicated by broken lines or alternate long and short dash lines, an ultrasonic wave from the speaker 27 is reflected by an object other than the target 100 or a reflected wave from the target 100 is further reflected by another object and collected by the microphone 32 in some cases.

In such a case, since the path indicated by the broken lines or the alternate long and short dash lines is longer than the path indicated by the solid lines, timing at which the microphone 32 collects the reflected wave is later than that of the reflected wave on the path indicated by the solid lines.

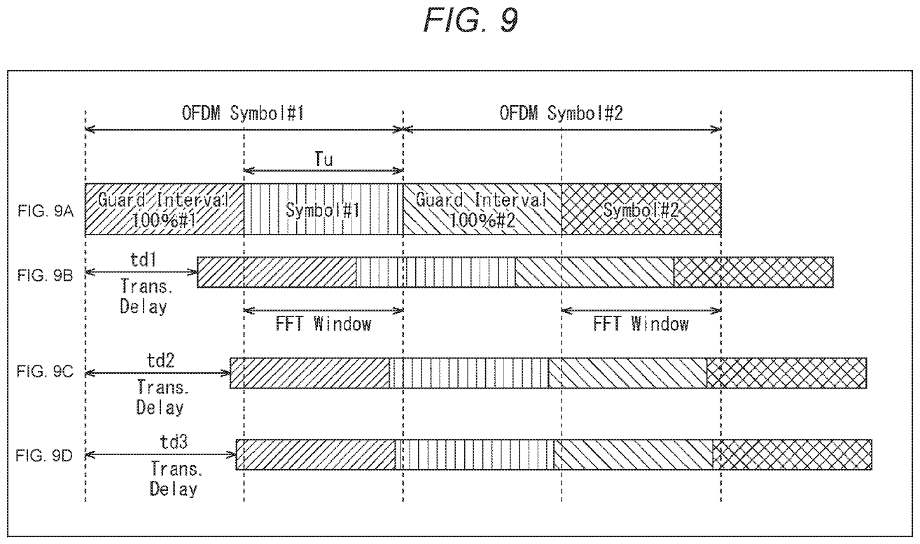

FIG. 9 illustrates timings of output and collection of ultrasonic waves in a case where multipath occurs as illustrated in FIG. 8. In a case where the ultrasonic wave output at the timing illustrated in A of FIG. 9 is reflected on the path indicated by the solid line, the ultrasonic wave is collected with a time difference td1 as illustrated in B of FIG. 9. Furthermore, in a case where an ultrasonic wave is reflected on the path indicated by the broken line, the ultrasonic wave is collected with a time difference td2 as illustrated in C of FIG. 9. In a case where an ultrasonic wave is reflected on the path indicated by the alternate long and short dash line, the ultrasonic wave is collected with a time difference td3 as illustrated in D of FIG. 9.

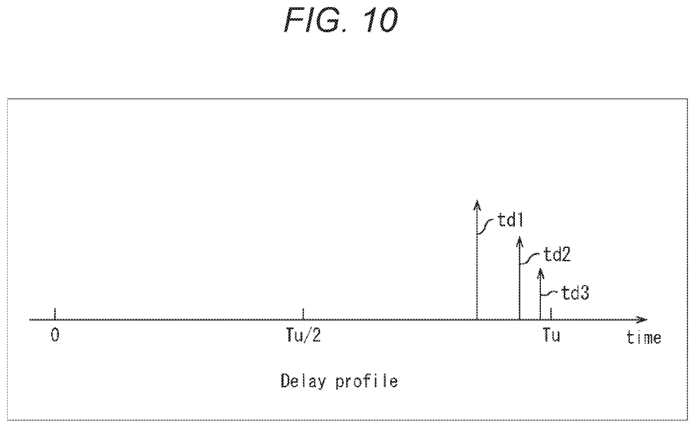

FIG. 10 illustrates a delay profile corresponding to the case illustrated in FIG. 9. In the distance measuring apparatus according to the first embodiment of the present technology, a time difference td appears as a peak corresponding to the time difference in the delay profile. In other words, peaks corresponding to the time differences td1, td2 appear in the delay profile. Therefore, it can be understood that if the time difference td is detected on the basis of the delay profile, multipath can be detected separately.

Note that as illustrated in FIG. 10, in a case where a plurality of peaks appears in the delay profile, it is only required, for example, to compare the delay profile obtained this time with the delay profile obtained immediately before, to select any peak according to a predetermined rule on the basis of the comparison result, and to detect the time difference td used to calculate the distance L to the target 100.

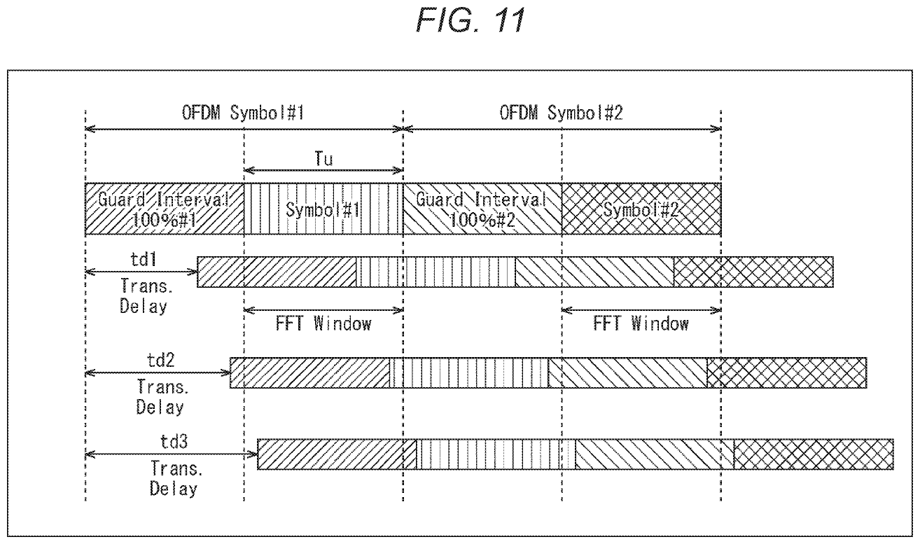

FIG. 11 illustrates an example of a reflected wave in which the time difference td3 exceeds the guard interval length. As illustrated in FIG. 11, the reflected wave collected over the guard interval length is in a situation where inter-symbol interference occurs, which causes disturbance for another reflected wave, and the delay time cannot be measured accurately.

<Regarding Distance Measuring Apparatus according to Second Embodiment of Present Technology>

Incidentally, as described above, in a case where the transmission unit 21 and the reception unit 31 are disposed adjacent to each other and further downsizing of them is promoted, crosstalk in which an ultrasonic wave output from the transmission unit 21 is directly collected by the reception unit 31 can occur.

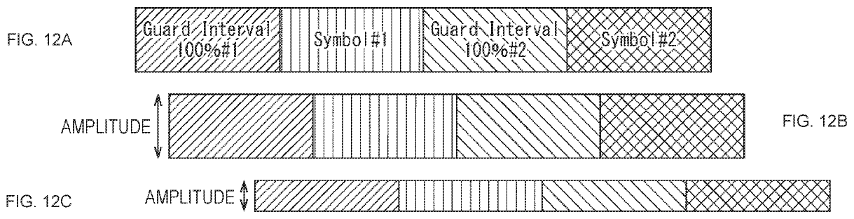

FIG. 12 is a diagram illustrating timings of output and collection of ultrasonic waves in a case where crosstalk occurs. A of FIG. 12 illustrates the output timing of an ultrasonic wave, B of FIG. 12 illustrates collection timing of crosstalk, and B of FIG. 12 illustrates collection timing of the reflected wave from the target 100.

As illustrated in B of FIG. 12, since an ultrasonic wave (hereinafter referred to as a crosstalk component) directly collected by crosstalk has no distance attenuation or attenuation due to reflection, the amplitude is greater than that of the reflected wave from the target 100 illustrated in C of FIG. 12.

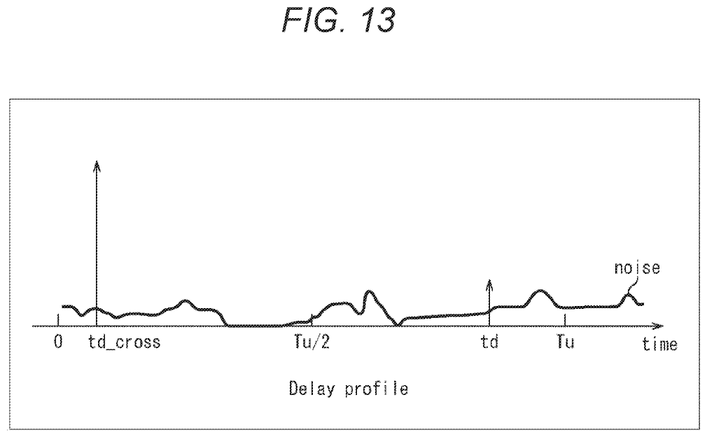

FIG. 13 illustrates a delay profile corresponding to a case where the crosstalk illustrated in FIG. 12 occurs.

As illustrated in FIG. 13, time difference td_cross of extremely short time corresponding to crosstalk appears in the delay profile in a case where crosstalk occurs, and the peak representing a time difference td corresponding to the reflected wave from the target 100 is buried in quantization noise by AD conversion and cannot be accurately detected. Therefore, the performance of distance measurement is degraded.

Therefore, next, a distance measuring apparatus capable of removing a crosstalk component will be described.

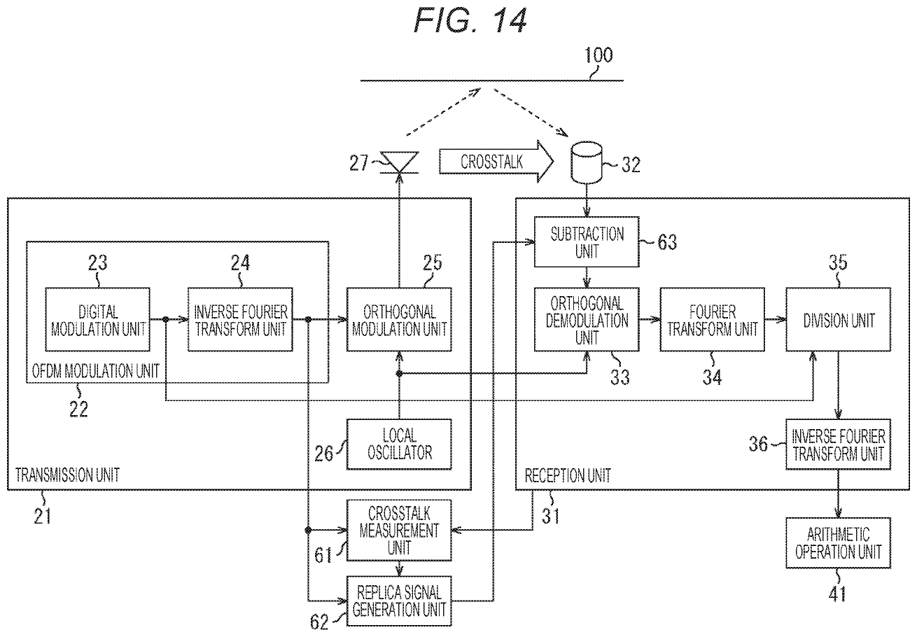

FIG. 14 is a block diagram illustrating a configuration example of a distance measuring apparatus according to a second embodiment of the present technology. In the second embodiment, a function capable of removing a crosstalk component is added to the above-described first embodiment.

In other words, in the distance measuring apparatus according to the second embodiment, a crosstalk measurement unit 61, a replica signal generation unit 62, and a subtraction unit 63 are added to the first embodiment illustrated in FIG. 3. The other constituents are common to those of the first embodiment, and are denoted by the same reference numerals, and thus the description thereof will be appropriately omitted.

The crosstalk measurement unit 61 measures crosstalk information (time difference td_cross, attenuation of amplitude of an OFDM signal, rotation of the phase) on the basis of the OFDM signal output from an inverse Fourier transform unit 24 and information obtained from each unit of a reception unit 31 by operating the distance measuring apparatus in a state where a target 100 does not exist or is extremely far away upon manufacture or the like, and supplies the measurement result to the replica signal generation unit 62. Note that it is assumed that when the crosstalk measurement unit 61 measures the crosstalk information, the replica signal generation unit 62 and the subtraction unit 63 as described later are not operated.

The replica signal generation unit 62 delays the OFDM signal output from the inverse Fourier transform unit by the time difference td cross, attenuates the amplitude of the OFDM signal, and rotates the phase, on the basis of the crosstalk information supplied from the crosstalk measurement unit 61, and moreover performs the same orthogonal modulation as a orthogonal modulation unit 25 does to generate a replica signal corresponding to the crosstalk component and outputs the replica signal to the subtraction unit 63.

The subtraction unit 63 subtracts the replica signal from the reception signal corresponding to the collection result of the microphone 32 (the reflected wave from the target 100 and the crosstalk component) and outputs the obtained reception signal to the orthogonal demodulation unit 33. With this arrangement, the orthogonal demodulation unit 33 is supplied with the reception signal from which the replica signal corresponding to the crosstalk component has been removed. The processes after the orthogonal demodulation unit 33 are common to those in the first embodiment, and thus the description thereof will be omitted.

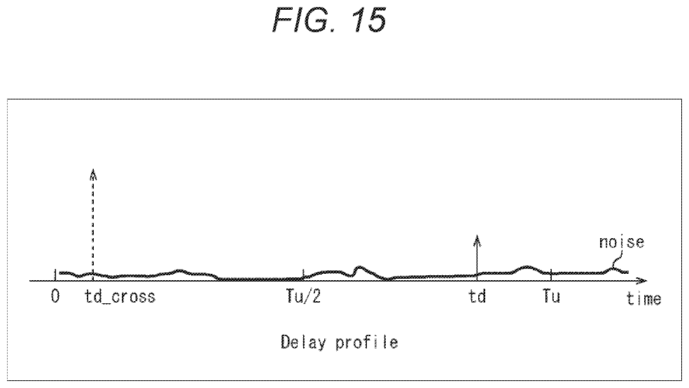

FIG. 15 is a diagram illustrating a delay profile corresponding to a case where the replica signal corresponding to the crosstalk component is subtracted.

The following can be said by comparing FIG. 15 with the delay profile corresponding to the case where the crosstalk occurs illustrated in FIG. 13. In other words, in the delay profile in a case where the replica signal corresponding to the crosstalk component is subtracted, a time difference td_cross of extremely short time corresponding to crosstalk does not appear. Furthermore, since there is no crosstalk component with large amplitude, quantization noise by AD conversion is reduced, a peak representing a time difference td corresponding to the reflected wave from the target 100 can be accurately detected. Therefore, the distance to the target 100 can be accurately measured.

Note that the crosstalk component that can occur in the distance measuring apparatus according to the second embodiment can change due to aging or the like. In that case, if a replica signal is generated on the basis of crosstalk information measured before change, in other words, upon manufacture, the crosstalk component cannot be removed accurately.

Therefore, in order to be able to cope with crosstalk due to aged deterioration, the crosstalk measurement unit 61 monitors the delay profile even in a case where the distance to the target 100 is measured. Then, in a case where the time difference td_cross corresponding to the crosstalk component appears in the delay profile, the crosstalk information is measured again in a manner similar to that upon manufacture. In this way, even if the crosstalk component changes due to aging, it is possible to cope with the change, and the distance to the target 100 can be accurately measured.

Note that the crosstalk measurement unit 61 may measure and update crosstalk information at a predetermined cycle. In this way, even if the crosstalk component changes due to aging, it is possible to cope with the change, and the distance to the target 100 can be accurately measured.

<Regarding Distance Measuring Apparatus according to Third Embodiment of Present Technology>

Incidentally, in a case of using an ultrasonic wave for distance measurement as in the present embodiment, it is ideal that frequency characteristics of an ultrasonic wave bandwidth of each of a speaker 27 that outputs an ultrasonic wave and a microphone 32 that collects the ultrasonic wave are flat. However, since the speaker 27 and the microphones 32, which are analog components, have individual-specific frequency characteristics, the problems described below can occur.

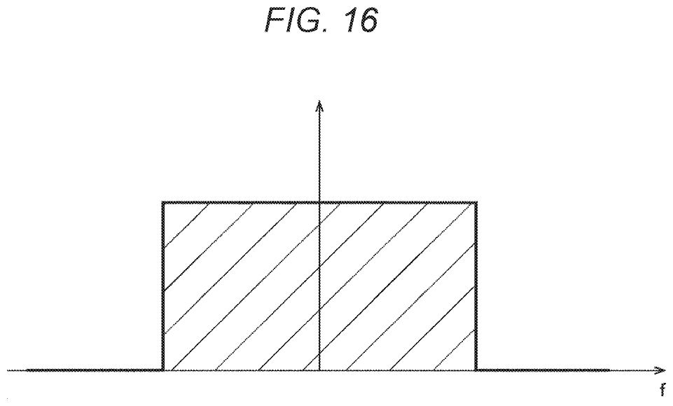

FIGS. 16 to 18 are diagrams for explaining the problem caused by the frequency characteristics of the speaker 27 and the microphone 32.

In a case where the frequency characteristics of the speaker 27 and the microphone 32 are flat, the spectrum after Fourier transform by a Fourier transform unit 34 of a reception unit 31 is flat without distortion as illustrated in FIG. 16.

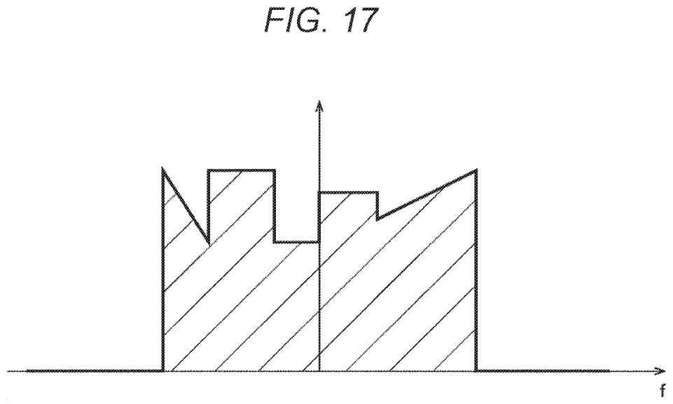

However, actually, the frequency characteristics of the speaker 27 and the microphone 32 exert an influence, and the spectrum after Fourier transform by the Fourier transform unit 34 of the reception unit 31 is distorted as illustrated in FIG. 17.

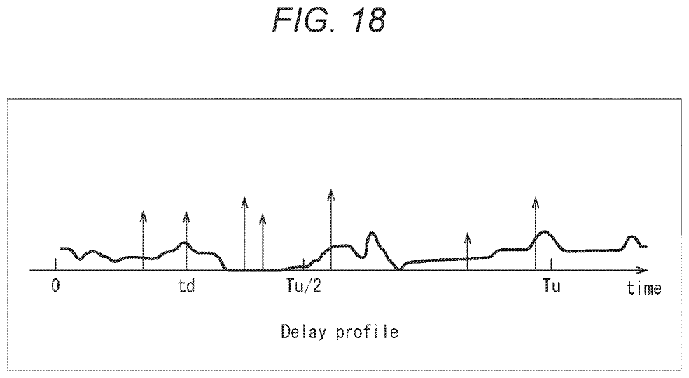

As described above, if the transfer function is calculated on the basis of the Fourier transform result in which distortion occurs and a delay profile is determined, as illustrated in FIG. 18, a plurality of peaks appears in the delay profile similarly to the state in which multipath is generated, and the peak corresponding to the reflected wave from a target 100 cannot be detected accurately.

Then, next, a distance measuring apparatus capable of removing the influence of frequency characteristics of the speaker 27 and the microphone 32 will be described.

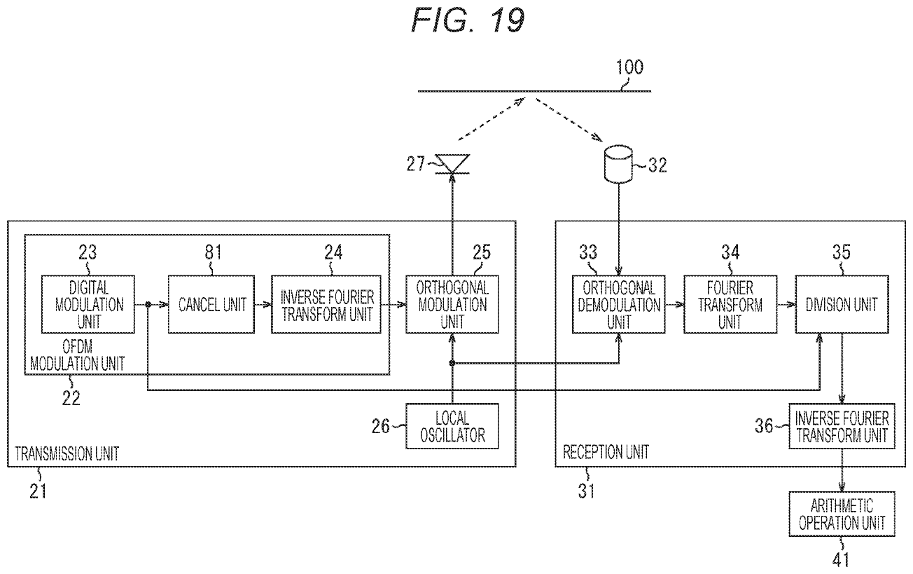

FIG. 19 is a block diagram illustrating a configuration example of a distance measuring apparatus according to a third embodiment of the present technology. In the third embodiment, a function capable of removing the influence of frequency characteristics of the speaker 27 and the microphone 32 is added to the above-described first embodiment.

In other words, in the distance measuring apparatus according to the third embodiment, a cancel unit 81 is added between the digital modulation unit 23 and the inverse Fourier transform unit 24 of the first embodiment illustrated in FIG. 3.

The other constituents are common to those of the first embodiment, and are denoted by the same reference numerals, and thus the description thereof will be appropriately omitted.

The cancel unit 81 causes the digital modulation unit 23 to output the inverse characteristics of the frequency characteristics of the speaker 27 and the microphone 32 held in advance and then outputs the inverse characteristics to the inverse Fourier transform unit 24. Note that it is assumed that as for the frequency characteristics of the speaker 27 and the microphone 32, a spectrum in which distortion after Fourier transform occurs as illustrated in FIG. 17 is measured upon manufacture, and the cancel unit 81 holds the inverse characteristics in advance.

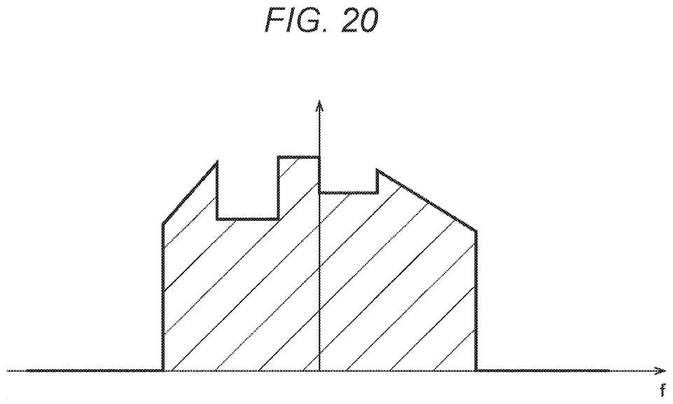

FIG. 20 illustrates the inverse characteristics of a case where the frequency characteristics of the speaker 27 and the microphone 32 measured upon manufacture are those illustrated in FIG. 17.

The specific processes in the cancel unit 81 is as follows.

X(i): signal of i-th subcarrier

M(i): frequency characteristic of the speaker 27 at the location of the i-th subcarrier

H(i): frequency characteristic of a channel at the location of i-th subcarrier

S(i): frequency characteristic of the microphone 32 at the location of the i-th subcarrier

N(i): AWGN at the location of i-th subcarrier

Y (i): reception signal of i-th subcarrier

In a case where each variable is defined as described above, the cancel unit 81 calculates the following equation (2).

X′(i)={(1/S(i)*1/M(i))*X(i)} (2)

In this case, the reception signal Y(i) is as indicated in the following equation (3).

$$\begin{matrix}Y ( i ) = {S ( i )}^{★} {H ( i )}^{★} {{M}^{★} ( i )}^{★} {X}^{′} ( i ) + N ( i ) \\ = {S ( i )}^{★} {H ( i )}^{★} {M ( i )}^{★} \{ {( 1 / {S ( i )}^{★} 1 / M ( i ) )}^{★} X ( i ) \} + N ( i ) \\ = {S ( i )}^{★} {( 1 / S ( i ) )}^{★} {H ( i )}^{★} {M ( i )}^{★} {( 1 / M ( i ) )}^{★} X ( i ) + N ( i ) \\ = {H ( i )}^{★} X ( i ) + N ( i )\end{matrix} \qquad ( 3 )$$

As apparent from the equation (3), it can be understood that the frequency characteristics of the speaker 27 and the microphone 32 are removed from the reception signal Y(i).

Therefore, in the case of the third embodiment of the present technology, since the frequency characteristics of the speaker 27 and the microphone 32 do not affect the reception signal, occurrence of such a problem that a plurality of peaks appears in the above-described delay profile can be prevented. Therefore, since the peak corresponding to the reflected wave from the target 100 can be accurately detected, the distance to the target 100 can be accurately performed.

Note that the above-described first to third embodiments can also be combined as appropriate.

Incidentally, the processes of the distance measuring apparatus according to the first to third embodiments described above can be performed by hardware or can be performed by software. In a case where the series of processes are performed by software, a program that configures the software is installed on a computer. Here, the computer includes a computer incorporated in dedicated hardware, or, for example, a general-purpose personal computer that can execute various functions by installing various programs.

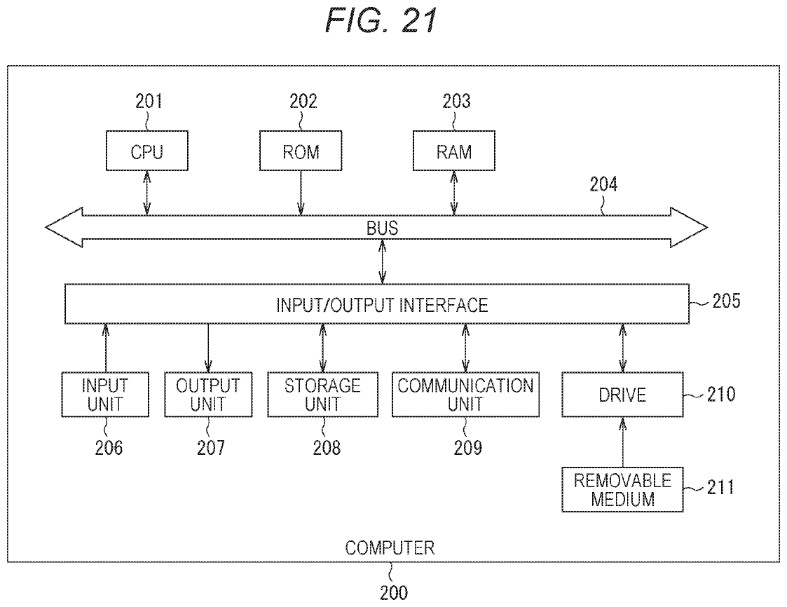

FIG. 21 is a block diagram illustrating an example of a hardware configuration of a computer that executes the series of processes described above according to a program.

In the computer, a central processing unit (CPU) 201, a read only memory (ROM) 202, and a random access memory (RAM) 203 are mutually connected by a bus 204.

Moreover, an input/output interface 205 is connected to the bus 204. An input unit 206, an output unit 207, a storage unit 208, a communication unit 209, and a drive 210 are connected to the input/output interface 205.

The input unit 206 includes a keyboard, a mouse, a microphone or the like. The output unit 207 includes a display, a speaker, or the like. The storage unit 208 includes a hard disk, a non-volatile memory, or the like. The communication unit 209 includes a network interface or the like. The drive 210 drives a removable medium 211 such as a magnetic disk, an optical disk, a magneto-optical disk, or a semiconductor memory.

In the computer configured as described above, for example, the CPU 201 loads the program stored in the storage unit 208 into the RAM 203 via the input/output interface 205 and the bus 204 and thus the above-described series of processes are performed.

The program executed by the computer (CPU 201) can be provided by being recorded on, for example, the removable medium 211 as a package medium or the like. Furthermore, the program can be provided via a wired or wireless transmission medium such as a local area network, the Internet, or digital satellite broadcasting.

In the computer, the program can be installed in the storage unit 208 via the input/output interface 205 by inserting the removable medium 211 into the drive 210. Furthermore, the program can be received by the communication unit 209 via a wired or wireless transmission medium and installed in the storage unit 208. In addition, the program can be installed in advance in the ROM 202 or the storage unit 208.

Note that the program executed by the computer may be a program that performs processes in chronological order according to the order described in the present specification, or may be a program that performs process in parallel, or at necessary timing, such as when a call is made.

<Example of Application to Moving Object>

The technology according to the present disclosure (the present technology) can be applied to various products. For example, the technology according to the present disclosure may be realized as an apparatus mounted on any type of a moving object such as an automobile, an electric car, a hybrid electric car, a motorcycle, a bicycle, a personal mobility vehicle, an airplane, a drone, a ship, or a robot.

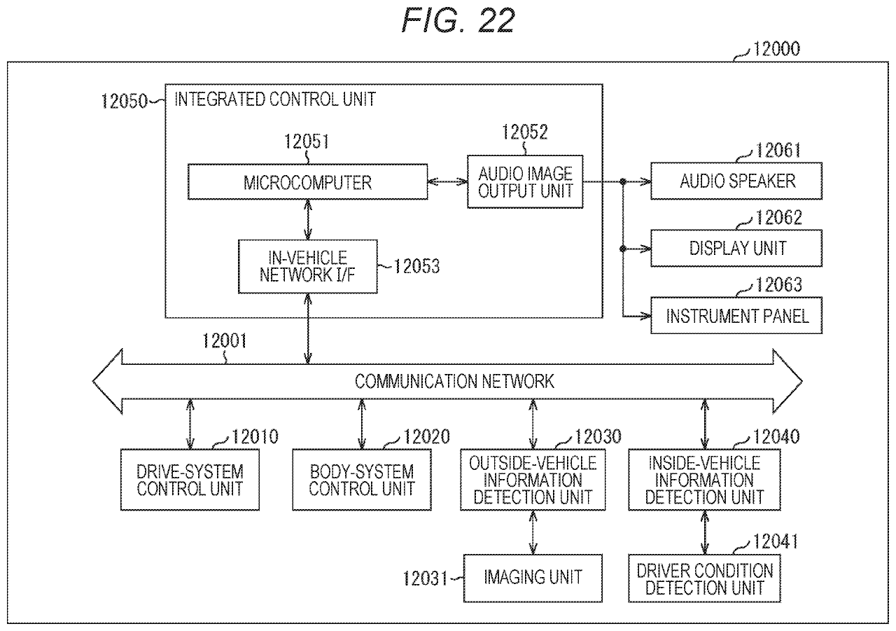

FIG. 22 is a block diagram illustrating a schematic configuration example of a vehicle control system which is an example of a moving object control system to which the technology according to the present disclosure can be applied.

A vehicle control system 12000 includes a plurality of electronic control units connected via a communication network 12001. In the example illustrated in FIG. 22, the vehicle control system 12000 includes a drive-system control unit 12010, a body-system control unit 12020, an outside-vehicle information detection unit 12030, an inside-vehicle information detection unit 12040, and an integrated control unit 12050. Furthermore, as a functional configuration of the integrated control unit 12050, a microcomputer 12051, an audio image output unit 12052, and an in-vehicle network interface (I/F) 12053 are illustrated.

The drive-system control unit 12010 controls the operation of devices related to the drive system of a vehicle according to various programs. For example, the drive-system control unit 12010 functions as a control device for a drive force generation device for generating drive force of the vehicle such as an internal combustion engine or a drive motor, a drive force transmission mechanism for transmitting drive force to wheels, a steering mechanism that adjusts the steering angle of the vehicle, and a braking device that generates braking force of the vehicle.

The body-system control unit 12020 controls the operation of various devices provided on a vehicle body according to the various programs. For example, the body-system control unit 12020 functions as a control device of a keyless entry system, a smart key system, a power window device, or various lamps such as a headlamp, a back lamp, a brake lamp, a blinker or a fog lamp. In this case, to the body-system control unit 12020, radio waves or signals of various switches transmitted from a portable machine substituting for a key can be input. The body-system control unit 12020 receives input of these radio waves or signals, and controls a door lock device, a power window device, a lamp and the like of the vehicle.

The outside-vehicle information detection unit 12030 detects information of the outside of the vehicle on which the vehicle control system 12000 is mounted. For example, an imaging unit 12031 is connected to the outside-vehicle information detection unit 12030. The outside-vehicle information detection unit 12030 causes the imaging unit 12031 to capture an image outside the vehicle, and receives the captured image. The outside-vehicle information detection unit 12030 may perform an object detection process of a person, a car, an obstacle, a sign, a character on a road surface, or the like or a distance detection process on the basis of the received image.

The imaging unit 12031 is an optical sensor that receives light and outputs an electric signal according to the amount of the light received. The imaging unit 12031 can output an electric signal as an image or can output the electric signal as distance measurement information. Furthermore, light received by the imaging unit 12031 may be visible light or invisible light such as infrared light.

The inside-vehicle information detection unit 12040 detects information of vehicle inside. For example, a driver condition detection unit 12041 that detects the condition of a driver is connected to the inside-vehicle information detection unit 12040. The driver condition detection unit 12041 includes, for example, a camera that captures an image of the driver, and the inside-vehicle information detection unit 12040 may calculate the degree of fatigue or the degree of concentration of the driver or may make a judgment as to whether or not the driver does not doze off, on the basis of detection information input from the driver condition detection unit 12041.

The microcomputer 12051 can arithmetically operate a control target value of the drive force generation device, the steering mechanism, or the braking device, on the basis of information of the inside and outside of the vehicle acquired by the outside-vehicle information detection unit 12030 or the inside-vehicle information detection unit 12040, and can output an control command to the drive-system control unit 12010. For example, the microcomputer 12051 can perform coordinated control aiming at realizing functions of an advanced driver assistance system (ADAS) including collision avoidance or shock mitigation of a vehicle, follow-up traveling based on inter-vehicle distance, traveling while maintaining vehicle speed, vehicle collision warning, vehicle lane deviation warning, or the like.

Furthermore, the microcomputer 12051 can perform coordinated control aiming at automatic driving or the like of autonomously traveling without depending on operation of the driver, by controlling the drive force generation device, the steering mechanism, the braking device, or the like on the basis of vehicle periphery information acquired by the outside-vehicle information detection unit 12030 or the inside-vehicle information detection unit 12040.

Furthermore, the microcomputer 12051 can output a control command to the body-system control unit 12020 on the basis of the outside-vehicle information acquired by the outside-vehicle information detection unit 12030. For example, the microcomputer 12051 can perform coordinated control aiming at antiglare such as switching from a high beam to a low beam by controlling the headlamp according to the position of the preceding car or the oncoming car detected by the outside-vehicle information detection unit 12030.

The audio image output unit 12052 transmits an output signal of at least one of audio or an image to an output device capable of visually or aurally notifying a passenger or the outside of the vehicle of information. In the example of FIG. 22, an audio speaker 12061, a display unit 12062, and an instrument panel 12063 are illustrated as examples of the output device. For example, the display unit 12062 may include at least one of an on-board display or a head-up display.

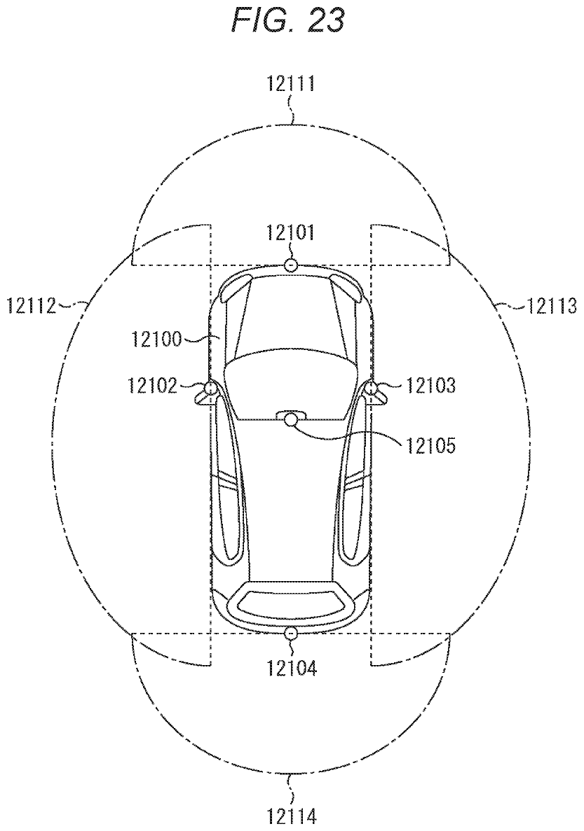

FIG. 23 is a diagram illustrating examples of installation locations of the imaging unit 12031.

In FIG. 23, a vehicle 12100 includes imaging units 12101, 12102, 12103, 12104, 12105 as the imaging unit 12031.

For example, the imaging units 12101, 12102, 12103, 12104, 12105 are provided at locations such as a front nose, side mirrors, a rear bumper, a back door, and an upper portion of a windshield of a vehicle cabin of the vehicle 12100. The imaging unit 12101 provided on the front nose and the imaging unit 12105 provided on the upper portion of the windshield inside the vehicle cabin mainly acquire images in front of the vehicle 12100. The imaging units 12102, 12103 provided on the side mirrors mainly acquire images on lateral sides of the vehicle 12100. The imaging unit 12104 provided on the rear bumper or the back door mainly acquires an image behind the vehicle 12100. The front images acquired by the imaging units 12101, 12105 are mainly used to detect a preceding vehicle, a pedestrian, an obstacle, traffic lights, a traffic sign, a traffic lane, or the like.

Note that, FIG. 23 illustrates examples of the image capturing ranges of the imaging units 12101 to 12104. An imaging range 12111 indicates the imaging range of the imaging unit 12101 provided on the front nose, imaging ranges 12112, 12113 indicate the imaging ranges of the imaging units 12102, 12103 provided on the side mirrors, respectively, and an imaging range 12114 indicates the imaging range of the imaging unit 12104 provided on the rear bumper or the back door. For example, by overlapping pieces of image data captured by the imaging units 12101 to 12104, a bird's eye view of the vehicle 12100 viewed from above can be obtained.

At least one of the imaging units 12101 to 12104 may have a function of acquiring distance information. For example, at least one of the imaging units 12101 to 12104 may be a stereo camera including a plurality of imaging elements, or an imaging element having pixels for phase difference detection.

For example, the microcomputer 12051 can extract, in particular, a closest three-dimensional object on a traveling road of the vehicle 12100, the three-dimensional object traveling at predetermined speed (for example, 0 km/h or more) in substantially the same direction as in the vehicle 12100 as a preceding car, by determining respective distances to the three-dimensional object in the imaging ranges 12111 to 12114, and the temporal changes of the distances (relative speed with respect to the vehicle 12100), on the basis of the distance information obtained from the imaging units 12101 to 12104. Moreover, the microcomputer 12051 can set an inter-vehicle distance to be secured behind the preceding car, and can perform automatic brake control (including follow-up stop control), automatic acceleration control (including follow-up start control), or the like. As described above, it is possible to perform coordinated control aiming at automatic driving or the like of travelling autonomously without depending on the driver's operation.

For example, on the basis of the distance information obtained from the imaging units 12101 to 12104, the microcomputer 12051 can classify three-dimensional object data relating to three-dimensional objects into two-wheeled vehicles, ordinary vehicles, large vehicles, pedestrians, utility poles, and other three-dimensional objects and extract them so as to be able to use them for automatic avoidance of obstacles. For example, the microcomputer 12051 identifies obstacles around the vehicle 12100 as obstacles visible to the driver of the vehicle 12100 and as obstacles hardly visible to the driver of the vehicle 12100. Then, the microcomputer 12051 judges the collision risk indicating the degree of risk of collision with each obstacle, and in a situation where there is a possibility of collision with the collision risk equal to or more than a setting value, the microcomputer 12051 can perform driving support for collision avoidance by outputting an alarm to the driver through the audio speaker 12061 or the display unit 12062 or performing forcible deceleration or avoidance steering through the drive-system control unit 12010.

At least one of the imaging units 12101 to 12104 may be an infrared camera that detects infrared light. For example, the microcomputer 12051 can recognize a pedestrian by judging whether or not a pedestrian is present in the images captured by the imaging units 12101 to 12104. Such pedestrian recognition is performed, for example, according to procedures for extracting characteristic points in images captured by the imaging units 12101 to 12104 as infrared cameras, and procedures for performing a pattern matching process on a series of characteristic points indicating the outline of an object to make a judgment as to whether or not the object is a pedestrian. If the microcomputer 12051 judges that a pedestrian is present in the captured images of the imaging units 12101 to 12104 and recognizes the pedestrian, the audio image output unit 12052 causes the display unit 12062 to display a square outline for emphasizing so as to be overlapped with the recognized pedestrian. Furthermore, the audio image output unit 12052 may cause the display unit 12062 to display an icon or the like indicating a pedestrian at a desired location.

An example of the vehicle control system to which the technology according to the present disclosure can be applied has been described above. For example, among the configurations described above, the technology according to the present disclosure can also be applied to the imaging unit 12031 that performs distance measurement, in lieu of the imaging unit 12031 that performs distance measurement.

Note that the embodiments of the present technology are not limited to the above-described embodiments, and various modifications can be made without departing from the scope of the present technology.

The present technology can also be configured as follows.

(1)

A distance measuring apparatus including:

an OFDM modulation unit configured to generate an OFDM signal by performing OFDM modulation on a transmission signal;

an output unit configured to output the OFDM signal by using an ultrasonic wave as a carrier wave;

a collecting unit configured to collect, as a reception signal, an ultrasonic wave as a reflected wave from a target of the ultrasonic wave output;

a demodulation unit configured to generate a demodulated signal by demodulating the reception signal;

a calculation unit configured to calculate a delay profile on the basis of an own signal obtained in the process of generating the OFDM signal and the demodulated signal; and

an arithmetic operation unit configured to determine delay time of the ultrasonic wave from the delay profile and to arithmetically operate the distance to the target on the basis of the delay time.

(2)

The distance measuring apparatus according to the (1), further including

a division unit configured to generate a transfer function by dividing the demodulated signal by the OFDM signal,

in which the calculation unit calculates the delay profile by performing an inverse Fourier transform on the transfer function.

(3)

The distance measuring apparatus according to the (1) or (2), further including

an orthogonal modulation unit configured to perform orthogonal modulation of the OFDM signal before being carried by the ultrasonic wave,

in which the demodulation unit generates the demodulated signal by performing orthogonal demodulation corresponding to the orthogonal modulation on the reception signal and performing Fourier transform.

(4)

The distance measuring apparatus according to any one of the (1) to (3),

in which the OFDM modulation unit provides a guard interval to the OFDM signal.

(5)

The distance measuring apparatus according to the (4), in which the OFDM modulation unit provides the guard interval that has a same length as OFDM effective symbol length.

(6)

The distance measuring apparatus according to any one of the (1) to (5),

in which the OFDM modulation unit sets an FFT size to a power of 2, the FFT size being a parameter in OFDM modulation, and sets the number of carrier waves to ½ of the FFT size.

(7)

The distance measuring apparatus according to any one of the (1) to (6), further including:

a replica signal generation unit configured to generate a replica signal corresponding to a crosstalk component; and

a subtraction unit configured to subtract the replica signal from the reception signal.

(8)

The distance measuring apparatus according to the (7), further including

a crosstalk measurement unit configured to measure crosstalk information, in which the replica signal generation unit generates the replica signal on the basis of the crosstalk information.

(9)

The distance measuring apparatus according to the (8), in which the crosstalk measurement unit measures, as the crosstalk information, at least one of delay time, attenuation of the amplitude of the OFDM signal, or rotation of a phase corresponding to crosstalk.

(10)

The distance measuring apparatus according to the (8) or (9),

in which the crosstalk measurement unit periodically updates the crosstalk information.

(11)

The distance measuring apparatus according to the (8) or (9),

in which the crosstalk measurement unit updates the crosstalk information in a case where a peak corresponding to crosstalk appears in the delay profile.

(12)

The distance measuring apparatus according to any one of the (1) and (11), further including

a cancel unit configured to correct distortion of the reception signal caused by a frequency characteristic of an ultrasonic speaker as the output unit and an ultrasonic microphone as the collecting unit.

(13)

The distance measuring apparatus according to (12), in which the cancel unit is included in the OFDM modulation unit.

(14)

The distance measuring apparatus according to the (13),

in which the cancel unit multiplies an inverse characteristic of the frequency characteristic of the ultrasonic speaker and the ultrasonic microphone, in the process of generating the OFDM signal.

(15)

A distance measuring method performed by a distance measuring apparatus, the method, by the distance measuring apparatus, including:

an OFDM modulation step of generating an OFDM signal by performing OFDM modulation on a transmission signal;

an output step of outputting the OFDM signal by using an ultrasonic wave as a carrier wave;

a collecting step of collecting, as a reception signal, an ultrasonic wave as a reflected wave from a target of the ultrasonic wave output;

a demodulation step of generating a demodulated signal by demodulating the reception signal;

a calculation step of calculating a delay profile on the basis of an own signal obtained in the process of generating the OFDM signal and the demodulated signal; and

an arithmetic operation step of determining delay time of the ultrasonic wave from the delay profile and arithmetically operating the distance to the target on the basis of the delay time.

(16)

A program causing a computer to function as: an OFDM modulation unit configured to generate an OFDM signal by performing OFDM modulation on a transmission signal;

an output unit configured to output the OFDM signal by using an ultrasonic wave as a carrier wave;

a collecting unit configured to collect, as a reception signal, an ultrasonic wave as a reflected wave from a target of the ultrasonic wave output;

a demodulation unit configured to generate a demodulated signal by demodulating the reception signal;

a calculation unit configured to calculate a delay profile on the basis of an own signal obtained in a process of generating the OFDM signal and the demodulated signal; and

an arithmetic operation unit configured to determine delay time of the ultrasonic wave from the delay profile and to arithmetically operate the distance to the target on the basis of the delay time.

### REFERENCE SIGNS LIST

21 Transmission unit
22 OFDM modulation unit
23 Digital modulation unit
24 Inverse Fourier transform unit
25 Orthogonal modulation unit
26 Local oscillator
27 Ultrasonic speaker
31 Reception unit
32 Ultrasonic speaker
33 Orthogonal demodulation unit
34 Fourier transform unit
35 Division unit
36 Inverse Fourier transform unit
41 Arithmetic operation unit
61 Crosstalk measurement unit
62 Replica signal generation unit
63 Subtraction unit
81 Cancel unit

1. A distance measuring apparatus comprising:
an OFDM modulation unit configured to generate an OFDM signal by performing OFDM modulation on a transmission signal;
an output unit configured to output the OFDM signal by using an ultrasonic wave as a carrier wave;
a collecting unit configured to collect, as a reception signal, an ultrasonic wave as a reflected wave from a target of the ultrasonic wave output;
a demodulation unit configured to generate a demodulated signal by demodulating the reception signal;
a calculation unit configured to calculate a delay profile on a basis of an own signal obtained in a process of generating the OFDM signal and the demodulated signal; and
an arithmetic operation unit configured to determine delay time of the ultrasonic wave from the delay profile and to arithmetically operate a distance to the target on a basis of the delay time.

2. The distance measuring apparatus according to claim 1, further comprising
a division unit configured to generate a transfer function by dividing the demodulated signal by the OFDM signal,
wherein the calculation unit calculates the delay profile by performing an inverse Fourier transform on the transfer function.

3. The distance measuring apparatus according claim 1, further comprising
an orthogonal modulation unit configured to perform orthogonal modulation of the OFDM signal before being carried by the ultrasonic wave,
wherein the demodulation unit generates the demodulated signal by performing orthogonal demodulation corresponding to the orthogonal modulation on the reception signal and performing Fourier transform.

4. The distance measuring apparatus according to claim 1,
wherein the OFDM modulation unit provides a guard interval to the OFDM signal.

5. The distance measuring apparatus according to claim 4,
wherein the OFDM modulation unit provides the guard interval that has a same length as OFDM effective symbol length.

6. The distance measuring apparatus according to claim 1,
wherein the OFDM modulation unit sets an FFT size to a power of 2, the FFT size being a parameter in OFDM modulation, and sets a number of carrier waves to ½ of the FFT size.

7. The distance measuring apparatus according to claim 1, further comprising:
a replica signal generation unit configured to generate a replica signal corresponding to a crosstalk component; and
a subtraction unit configured to subtract the replica signal from the reception signal.

8. The distance measuring apparatus according to claim 7, further comprising
a crosstalk measurement unit configured to measure crosstalk information,
wherein the replica signal generation unit generates the replica signal on a basis of the crosstalk information.

9. The distance measuring apparatus according to claim 8,
wherein the crosstalk measurement unit measures, as the crosstalk information, at least one of delay time, attenuation of amplitude of the OFDM signal, or rotation of a phase corresponding to crosstalk.

10. The distance measuring apparatus according claim 8,
wherein the crosstalk measurement unit periodically updates the crosstalk information.

11. The distance measuring apparatus according claim 8,
wherein the crosstalk measurement unit updates the crosstalk information in a case where a peak corresponding to crosstalk appears in the delay profile.

12. The distance measuring apparatus according to claim 1, further comprising
a cancel unit configured to correct distortion of the reception signal caused by a frequency characteristic of an ultrasonic speaker as the output unit and an ultrasonic microphone as the collecting unit.

13. The distance measuring apparatus according to claim 12,
wherein the cancel unit is included in the OFDM modulation unit.

14. The distance measuring apparatus according to claim 13,
wherein the cancel unit multiplies an inverse characteristic of the frequency characteristic of the ultrasonic speaker and the ultrasonic microphone, in the process of generating the OFDM signal.

15. A distance measuring method performed by a distance measuring apparatus, the method, by the distance measuring apparatus, comprising:
an OFDM modulation step of generating an OFDM signal by performing OFDM modulation on a transmission signal;
an output step of outputting the OFDM signal by using an ultrasonic wave as a carrier wave;
a collecting step of collecting, as a reception signal, an ultrasonic wave as a reflected wave from a target of the ultrasonic wave output;
a demodulation step of generating a demodulated signal by demodulating the reception signal;
a calculation step of calculating a delay profile on a basis of an own signal obtained in a process of generating the OFDM signal and the demodulated signal; and
an arithmetic operation step of determining delay time of the ultrasonic wave from the delay profile and arithmetically operating a distance to the target on a basis of the delay time.

16. A program causing a computer to function as:
an OFDM modulation unit configured to generate an OFDM signal by performing OFDM modulation on a transmission signal;
an output unit configured to output the OFDM signal by using an ultrasonic wave as a carrier wave;
a collecting unit configured to collect, as a reception signal, an ultrasonic wave as a reflected wave from a target of the ultrasonic wave output;
a demodulation unit configured to generate a demodulated signal by demodulating the reception signal;
a calculation unit configured to calculate a delay profile on a basis of an own signal obtained in a process of generating the OFDM signal and the demodulated signal; and
an arithmetic operation unit configured to determine delay time of the ultrasonic wave from the delay profile and to arithmetically operate a distance to the target on a basis of the delay time.
